(19) United States
(12) Patent Application Publication
(10) Pub. No.: US 2010/0185642 A1
(43) Pub. Date: Jul. 22, 2010

(54) INTEREST-BASED LOCATION TARGETING ENGINE

(75) Inventors: Christopher William Higgins, Portland, OR (US); Marc Eliot Davis, San Francisco, CA (US); Christopher Todd Paretti, San Francisco, CA (US); Carrie Burgener, Mountain View, CA (US); Rahul Nair, Sunnyvale, CA (US); Simon P. King, Berkeley, CA (US)

Correspondence Address: BAKER BOTTS L.L.P., 2001 ROSS AVENUE, 6TH FLOOR, DALLAS, TX, 75201, US

(73) Assignee: Yahoo! Inc., Sunnyvale, CA (US)

(21) Appl. No.: 12/357,345

(22) Filed: Jan. 21, 2009

(51) Int. Cl. G06F 17/30

(52) U.S. Cl. 707/758; 707/E17.071

(57) ABSTRACT

A method for targeted advertisement is provided, for which one or more tags relating to an advertisement is/are determined, one or more of the most representative entities for the tag(s) is/are determined, and the advertisement is targeted to the one or more most representative entities. In addition, for each of a plurality of tags, one or more of the most representative entities is/are determined based on term frequency-inverse document frequency, such that an entity is relatively more representative of a tag if the tag is more uniquely and/or frequently associated with the entity. For each tag, the associated entities may be divided into multiple categories, such that one or more most representative entities within each category is/are determined for each tag.

### TECHNICAL FILED

Generally, the present disclosure relates to targeted advertisement. More specifically, the present disclosure relates to targeting advertisement to selected real and/or virtual world entities based on the relative levels of representativeness the entities provide to one or more tags relating to the advertisement.

### BACKGROUND

A global telecommunications network has become an integral part of people's lives. In a broader sense, the global telecommunications network encompasses many interconnected networks at various levels and of different forms including, for example, computer networks, telephone networks, satellite networks, etc. People interact with various portions of the global telecommunications network (e.g., browsing the world wide web, gathering information from various resources, posting text or media files online, etc.) and with other people via various portions of the global telecommunications network (e.g., making telephone calls, sending emails or instant messages, chatting in online chat rooms, conducting business transactions at e-commerce websites, etc.) using various types of electronic devices (e.g., computers, smart telephones, smart appliances or vehicles, personal digital assistants (PDA), etc.).

As a result of people using their electronic devices in connection with portions of the global telecommunications network, a great deal of information is generated, which may provide insight into people's daily lives: where do they go, where do they work and live, with whom do they socialize, what activities do they conduct, what daily or monthly schedules do they follow, what merchandises do they purchase, and so on. In addition, some people provide their profiles to websites, such as when they become registered users of these websites or through daily content or status publication services. The profile data may include demographical information such as a person's ethnicity, age, gender, marital or family status, education level, income bracket, profession, hobbies, interests, etc. These types of information may be used to provide commercial opportunities to advertisers and businesses.

Advertisement, whether conducted online or in the real world, has long been one of the most important aspects of the world of commerce. Constant effort is made to improve the effectiveness and efficiency of advertisement. Advertisers generally prefer to achieve maximum return for their money and effort spent on advertisement. Often, it is desirable to target specific advertisement toward an appropriate audience, i.e., consumers who have relatively higher degree of interest in the subject matter of the advertisement. Similarly, it is often more effective to target specific advertisement at appropriate locations and/or during appropriate time intervals. For example, an advertisement about luxury sports cars may be more effective when placed in a web page whose content relates to automobiles than in a web page whose content relates to classical music. Similarly, the luxury sports car advertisement may be more effective when placed in a stadium during race car events than in an opera house.

There has been some effort to personalize or individualize advertisement. Common examples include making product recommendations based on people's purchasing history or placing individualized ad banners in web pages based on people's browsing history. However, personalized targeted advertisement still requires further improvement.

### SUMMARY

Generally, the present disclosure relates to targeted advertisement. More specifically, the present disclosure relates to targeting advertisement to selected real and/or virtual world entities based on the relative levels of representativeness the entities provide to one or more tags relating to the advertisement.

In the context of the present disclosure, “W4 data” refers to information related to the “where, when, who, and what,” which may be used to describe both real world entities (RWE), such as a person, an animal, an object, a device, an event, an activity, a location, a time, etc., and virtual world entities, such as a concept, a topic, an online site, a process, an application, a location, a virtual persona, etc. W4 data may be generated and collected via a variety of methods, such as from online and offline activities.

An “entity,” in the broadest sense, refers to anything that may exist in either the real or the virtual world. Within the real world, an entity may be a person, an animal, an object, an event, an activity, etc. Within the virtual world, an entity may be a concept, a topic, an idea, a process, an application, an online site, etc. In various embodiments, an entity may be represented by one or more pieces of W4 data.

A “tag” refers to a free-form text string that may be attached to or associated with a piece of data, and more specifically, a piece of W4 metadata attributed to some other data or metadata. Each piece of W4 data may represent a real world or virtual world entity. Thus, a tag may be associated with a real world or virtual world entity. A tag, in general, describes one or more aspects or attributes of the associated piece of data, i.e., the real world or virtual world entity, with which it is associated. A tag may be explicitly or implicitly generated. Each real world or virtual world entity may be associated with one or more tags. Each tag may be associated with a real world or virtual world entity one or more times. In addition, a tag may be associated with a group of related real world or virtual world entities.

According to various embodiments of the present disclosure, for each available tag, the most representative real world or virtual world entities associated with the tag are determined based on term frequency-inverse document frequency (tf-idf). The real world or virtual world entities may be divided into various categories and subcategories, and within each, the most representative real world or virtual world entities associated with each tag are determined. For example, one category may relate to locations, distances, or proximity, i.e., the “where” data, and for each tag, the most representative locations associated with the tag are determined. Another category may relate to time, i.e., the “when” data, and for each tag, the most representative time intervals associated with the tag are determined. A third category may relate to people or groups of people, i.e., the “who” data, and for each tag, the most representative people, i.e., users, associated with the tag are determined. A fourth category may relate to real world objects, interests, and activities, i.e., the “what” data, and for each tag, the most representative objects, interests, and activities associated with the tag are determined. Alternatively, real world or virtual world entities may be divided into various categories and subcategories based upon some combinations of all four of the above categories, e.g. by location, time, user demographic, and user interest or activity data. Any number of such categories may exist and may be used over time to distinguish among real world and virtual world entities.

According to various embodiments, the relatively more unique and/or more frequent a tag is associated with an entity in comparison to all the other available entities, the relatively more representative the entity is for the tag.

The most representative entities for each tag may be reevaluated and updated from time to time or as new information becomes available.

Subsequently, the tags and their most representative entities are used for targeted advertisement. According to various embodiments, for an advertisement, the most representative entities (e.g., locations, time intervals, people, activities, etc.) for the tag(s) that relate(s) to the subject matter or content of the advertisement are selected as the targeted entities of the advertisement. An advertisement may be related to one or more tags. Whether a tag relates to an advertisement may be explicitly specified or implicitly determined based on the subject matter or content of the advertisement. The advertisement may be delivered to its targeted entities in a variety of ways.

These and other features, aspects, and advantages of the disclosure are described in more detail below in the detailed description and in conjunction with the following figures.

### BRIEF DESCRIPTION OF THE DRAWINGS

The present disclosure is illustrated by way of example, and not by way of limitation, in the figures of the accompanying drawings and in which like reference numerals refer to similar elements and in which:

FIG. 1A illustrates a hierarchical tree structure that may be used to represent and organize various locations.

FIG. 1B illustrates a linear structure that may be used to represent and organize temporal points.

FIG. 1C illustrates a social network.

FIG. 2 illustrates a real world entity having a unique identifier and is associated with multiple tags.

FIG. 3 illustrates a method of targeted advertisement according to one embodiment of the present disclosure.

FIG. 4 illustrates a general computer system suitable for implementing embodiments of the present disclosure.

### DETAILED DESCRIPTION

The present disclosure is now described in detail with reference to a few preferred embodiments thereof as illustrated in the accompanying drawings. In the following description, numerous specific details are set forth in order to provide a thorough understanding of the present disclosure. It is apparent, however, to one skilled in the art, that the present disclosure may be practiced without some or all of these specific details. In other instances, well known process steps and/or structures have not been described in detail in order to not unnecessarily obscure the present disclosure. In addition, while the disclosure is described in conjunction with the particular embodiments, it should be understood that this description is not intended to limit the disclosure to the described embodiments. To the contrary, the description is intended to cover alternatives, modifications, and equivalents as may be included within the spirit and scope of the disclosure as defined by the appended claims.

According to various embodiments of the present disclosure, W4 data, i.e., information relating to the “where, when, who, and what,” and tags associated with the real world and virtual world entities represented by the W4 data are generated and collected using various methods. For each tag, the most representative entities for the tag are determined using term frequency-inverse document frequency. According to various embodiments, the relatively more unique and/or more frequent a tag is associated with an entity in comparison to all the other available entities, the relatively more representative the entity is for the tag. The information is then used for targeted advertisement.

According to various embodiments of the present disclosure, for an advertisement, the most representative entities (e.g., locations, time intervals, people, activities, etc.) for the tag(s) that relate(s) to or describe(s) the subject matter or content of the advertisement are selected as the targeted entities for the advertisement. The advertisement may be delivered to the targeted entities in using various methods.

### W4: Where, When, Who, What

In the context of the present disclosure, “W4 data” refers to information related to the “where, when, who, and what,” which may be used to describe both real world entities (RWE) and virtual world concepts or topics. A real word entity (RWE) refers to an entity that exists in the real world, such as, for example, a person, an animal, an object, a device, a location, an event, an activity, a time or time interval, an organization, etc. In the world of computers, there also exists a virtual world, also referred to as an online world. Various objects, concepts, topics may exist in the virtual world. Common examples of entities that exist in the virtual world may include, without limitation, web pages, emails, messages, digital files, online activities, topics of interests, abstract ideas, etc. Thus, in the broadest sense, an entity may be anything that may exists in the real or the virtual world. According to various embodiments, entities may be represented by the W4 data. In other words, the W4 data may include data relating to both the real world entities and the virtual world entities.

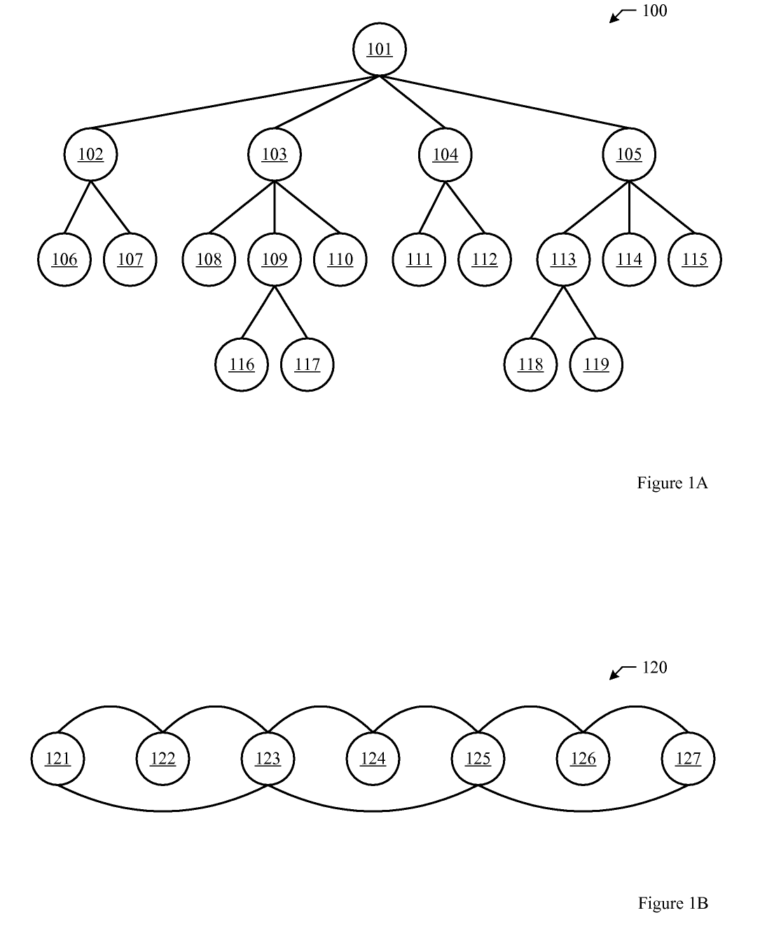

Generally speaking, the spatial “where” data refer to locations, which may include geographical locations in the real, physical world as well as virtual locations in the virtual world. A geographical location may refer to an area of any size. On the larger scale, a state, a country, a continent, even the entire planet may each be considered a geographical location. On the smaller scale, a city, a few street blocks, a building, or a specific spot may each be considered a geographical location. Consequently, geographical locations may be organized using a hierarchical tree structure, such as the one illustrated in FIG. 1A. In FIG. 1A, the hierarchical tree structure 100 has multiple levels of nodes and each node represents a geographical location. Locations representing larger areas are positioned near the top of the tree 100 (e.g., nodes 101, 102, 103, 104, and 105), and locations representing smaller areas are positioned near the bottom of the tree 100 (e.g., nodes 116, 117, 118, and 119). The positioning of the nodes indicates the relationships among the various locations. For example, node 101 has four branches: nodes 102, 103, 104, and 105, which indicates that the location area represented by node 101 encompasses the four location areas represented by nodes 102, 103, 104, and 105 respectively. At the same time, the four location areas represented by nodes 102, 103, 104, and 105 are relatively close to each other since they are enclosed in the same larger location area represented by node 101. Similarly, node 102 has two branches: nodes 106 and 107, which indicates that the location area represented by node 102 is larger than the two location areas represented by nodes 106 and 107 respectively and encompasses the two location areas represented by nodes 106 and 107 respectively. Furthermore, since node 101 is at the top of the tree 100, the location area represented by node 101 is the largest area in the context of this tree 100 and encompasses all the smaller areas represented by the other nodes in the tree 100.

A virtual location may refer to a location in the virtual world, such as a chat room, a blog, a website, a virtual environment, etc. Although some virtual locations have various types of relationships among themselves, it is not necessary for all virtual locations to exist within a hierarchy. For example, an online service provider such as Yahoo!® Group may host many discussion groups that are divided into categories and sub-categories so that the groups may be arranged in a hierarchy. On the other hand, the discussion groups hosted by Yahoo!® Group may not have any relationship with the discussion groups hosted by another online service provider such as Baidu's discussion bars.

In addition to physical or virtual locations, the temporal “where” data may be extended to include events, activities, sensors, or other types of entities that are associated with a spatial reference point or location.

The “when” data refer to temporal information, i.e., information relating to time, which may be a specific point in time, a period of time, a pattern with respect to time, etc. Since time is linear in the ordinary cases, temporal data may be organized in a linear structure, such as the one illustrated in FIG. 1B. Each node in FIG. 1B represents a period of time or a point in time. Often, patterns with respect to time may emerge from a relatively large set of W4 data. For example, the days of the week may be divided into weekdays and weekends. On weekdays, a person usually follows some form of routine (e.g., at work during the day, at home in the evenings). On the weekends, a person's behavioral patterns may not be as consistent as on weekdays (e.g., attending a concert on one Saturday but visiting with families on another Saturday). In another example, a day may be divided into morning, afternoon, and evening; a year may be divided into twelve month or four seasons. Thus, between temporal points, there are linear distances and periodic distances. A linear distance refers to the distance between two temporal points in real time. For example, from Monday 8:00 am to Tuesday 8:00 am, the linear distance is 24 hours, and from Jan. 1, 2008 to Jan. 1, 2009, the linear distance is one year. A periodic distance refers to the distance between two temporal points within the context of various temporal patterns.

The “where” data may be extended to include events associated with temporal points, such as natural temporal events, collective user temporal events (e.g., holidays, anniversaries, elections, etc.), and user-defined temporal events (e.g., birthdays, smart-timing programs, etc.).

The social “who” data refer to information relating to individual people as well as interactions and relationships among the people. Each person is associated with other people through various relationships: families, friends, co-workers, acquaintances, etc. Consequently, each person has a social group. The people and their social connections may be represented in a mesh structure, such as the one illustrated in FIG. 1C. Each node in FIG. 1C represents a person and each edge connecting two nodes represents a social relationship or connection between two people represented by the two nodes respectively. For example, the person represented by node 131 has direct relationships with the four people represented by nodes 132, 139, 140, and 141 respectively. The relationships may be different. Some relationships may be socially closer than others. The person represented by node 132 may be a friend of the persona represented by node 131; the person represented by node 139 and the persona represented by node 131 may be husband and wife; and so on.

Often, two people may have multiple types of relationships. For example, two people may be friends, co-workers, and may frequently participate in the same activities. A different edge may represent each of these different relationships. Thus, two nodes representing two people may be connected by multiple edges, each representing a different type of relationship. Sometimes, multiple persons may be grouped together according to various criteria, and a group of people may be treated as a unit. When people interact with each other, the interactions may be direct and personal or via proxies (e.g., devices, agents, etc.).

The topical “what” data refer to both the physical and the virtual entities, objects, activities, topics, concepts, etc. For example, it may refer to a physical object (e.g., a device, an animal, a piece of equipment, etc.), an event, an environment, an activity, a concept, a topic, a piece of information, a piece of news, an abstract idea, weather, news, information, etc. In fact, in a broader sense, the “what” data may refer to a great variety of objects and concepts that exist in the physical and the virtual world.

One skilled in the art will understand that FIGS. 1A-1C are simplified for illustration purposes. In practice, these structures have much greater complexity in terms of the number of nodes and the relationships among the nodes.

Pieces of W4 data are often interconnected. A person may be at a particular location during a particular time interval performing a particular activity. Within this context, the person “who”, the location “where”, the time interval “when”, and the activity “what” are interconnected. In a more concrete example, a man may attend a ballet performance at the War Memorial Opera House in San Francisco on a Saturday evening. Here, the “who” is the man; the “where” is the War Memorial Opera House in San Francisco; the “when” is Saturday evening; and the “what” is the ballet performance. The four pieces of W4 data together describe an event. If the man attends the ballet performance with his wife, then the woman is another piece of “who” data. The two pieces of “who” data representing the man and the woman are not only socially connected, being husband and wife, but are also connected to the same event, both attending the same ballet performance. If the same concept is extended to all the W4 data available, then the entities they represent may be interconnected in one way or another, such as via social connections, temporal connections, location connections, activity connections, event connections, co-presence connections, etc.

One skilled in the art will appreciate that as more data becomes available, various types of patterns, e.g., behavioral patterns, interest patterns, social patterns, etc., will emerge. These patterns may be used to predict future occurrences. For example, if is know that a particular group of people, e.g., a family, often visits a particular place during a particular time, e.g., visiting Hawaii during the month of August for a family vacation, then it may be predicted that the same family will likely to visit Hawaii again in August the next year. In other words, with sufficient amount of data, it may be possible to predict what a particular group of people is likely to do given a specific point in space-time.

The W4 data may be generated and collected via various methods, one of which is within the context a W4 Communications Network.

### W4 COMN: W4 Communications Network

A “W4 Communications Network” or W4 COMN, provides information related to the “where, when, who, and what” of interactions within the network. According to various embodiments, the W4 COMN is a collection of users, devices, and processes that foster both synchronous and asynchronous communications between users and their proxies, providing an instrumented network of sensors providing data recognition and collection in real-world environments about any subject, location, user, or combination thereof.

According to various embodiments, the W4 COMN is able to handle the routing/addressing, scheduling, filtering, prioritization, replying, forwarding, storing, deleting, privacy, transacting, triggering of a new message, propagating changes, transcoding, and/or linking. Furthermore, these actions may be performed on any communication channel accessible by the W4 COMN.

The W4 COMN uses a data modeling strategy for creating profiles for not only users and locations, but also any device on the network and any kind of user-defined data with user-specified conditions. Using social, spatial, temporal, and logical data available about a specific user, topic or logical data object, every entity known to the W4 COMN can be mapped and represented against all other known entities and data objects in order to create both a micro graph for every entity as well as a global graph that relates all known entities with one another. According to various embodiments, such relationships between entities and data objects are stored in a global index within the W4 COMN.

A W4 COMN network relates to what may be termed “real-world entities”, or RWEs. A RWE refers to, without limitation, a person, device, location, or other physical thing known to a W4 COMN. In one embodiment, each RWE known to a W4 COMN is assigned a unique W4 identification number that identifies the RWE within the W4 COMN.

RWEs may interact with the network directly or through proxies, which may themselves be RWEs. Examples of RWEs that interact directly with the W4 COMN include any device such as a sensor, motor, or other piece of hardware connected to the W4 COMN in order to receive or transmit data or control signals. RWE may include all devices that can serve as network nodes or generate, request and/or consume data in a networked environment or that can be controlled through a network. Such devices include any kind of “dumb” device purpose-designed to interact with a network (e.g., cell phones, cable television set top boxes, fax machines, telephones, and radio frequency identification (RFID) tags, sensors, etc.).

Examples of RWEs that may use proxies to interact with W4 COMN network include non-electronic entities including physical entities, such as people, locations (e.g., states, cities, houses, buildings, airports, roads, etc.) and things (e.g., animals, pets, livestock, gardens, physical objects, cars, airplanes, works of art, etc.), and intangible entities such as business entities, legal entities, groups of people or sports teams. In addition, “smart” devices (e.g., computing devices such as smart phones, smart set top boxes, smart cars that support communication with other devices or networks, laptop computers, personal computers, server computers, satellites, etc.) may be considered RWE that use proxies to interact with the network, where software applications executing on the device that serve as the devices' proxies.

According to various embodiments, a W4 COMN may allow associations between RWEs to be determined and tracked. For example, a given user (an RWE) can be associated with any number and type of other RWEs including other people, cell phones, smart credit cards, personal data assistants, email and other communication service accounts, networked computers, smart appliances, set top boxes and receivers for cable television and other media services, and any other networked device. This association can be made explicitly by the user, such as when the RWE is installed into the W4 COMN.

An example of this is the set up of a new cell phone, cable television service or email account in which a user explicitly identifies an RWE (e.g., the user's phone for the cell phone service, the user's set top box and/or a location for cable service, or a username and password for the online service) as being directly associated with the user. This explicit association can include the user identifying a specific relationship between the user and the RWE (e.g., this is my device, this is my home appliance, this person is my friend/father/son/etc., this device is shared between me and other users, etc.). RWEs can also be implicitly associated with a user based on a current situation. For example, a weather sensor on the W4 COMN can be implicitly associated with a user based on information indicating that the user lives or is passing near the sensor's location.

According to various embodiments, a W4 COMN network may additionally include what may be termed “information-objects”, hereinafter referred to as IOs. An information object (IO) is a logical object that may store, maintain, generate or otherwise provides data for use by RWEs and/or the W4 COMN. In one embodiment, data within in an IO can be revised by the act of an RWE An IO within in a W4 COMN can be provided a unique W4 identification number that identifies the IO within the W4 COMN.

IOs include passive objects such as communication signals (e.g., digital and analog telephone signals, streaming media and inter-process communications), advertisements, email messages, transaction records, virtual cards, event records (e.g., a data file identifying a time, possibly in combination with one or more RWEs such as users and locations, that can further be associated with a known topic/activity/significance such as a concert, rally, meeting, sporting event, etc.), recordings of phone calls, calendar entries, web pages, database entries, electronic media objects (e.g., media files containing songs, videos, pictures, images, audio messages, phone calls, etc.), electronic files and associated metadata.

In one embodiment, IOs include any executing process or application that consumes or generates data such as an email communication application (such as Outlook by Microsoft Inc., or Yahoo! Mail by Yahoo! Inc.), a calendaring application, a word processing application, an image editing application, a media player application, a weather monitoring application, a browser application and a web page server application. Such active IOs can or can not serve as a proxy for one or more RWEs. For example, voice communication software on a smart phone can serve as the proxy for both the smart phone and for the owner of the smart phone.

In one embodiment, for every IO there are at least three classes of associated RWEs. The first is the RWE that owns or controls the IO, whether as the creator or a rights holder (e.g., an RWE with editing rights or use rights to the IO). The second is the RWE(s) that the IO relates to, for example by containing information about the RWE or that identifies the RWE. The third are any RWEs that access the IO in order to obtain data from the IO for some purpose.

Within the context of a W4 COMN, “available data” and “W4 data” means data that exists in an IO or data that can be collected from a known IO or RWE such as a deployed sensor. Within the context of a W4 COMN, “sensor” means any source of W4 data including PCs, phones, portable PCs or other wireless devices, household devices, cars, appliances, security scanners, video surveillance, RFID tags in clothes, products and locations, online data or any other source of information about a real-world user/topic/thing (RWE) or logic-based agent/process/topic/thing (IO).

W4 COMN is described in more detail in: (1) U.S. patent application Ser. No. 12/273,259, filed on Nov. 18, 2008, entitled “System and Method for URL Based Query for Retrieving Data Related to a Context;” (2) U.S. patent application Ser. No. ______, filed on ______, 2009, entitled “Optimization of Map Views Based on Real-Time Data;” and (3) U.S. patent application Ser. No. 12/242,656, filed on Sep. 30, 2008, entitled “System and Method for Context Enhanced Ad Creation.”

### Tag

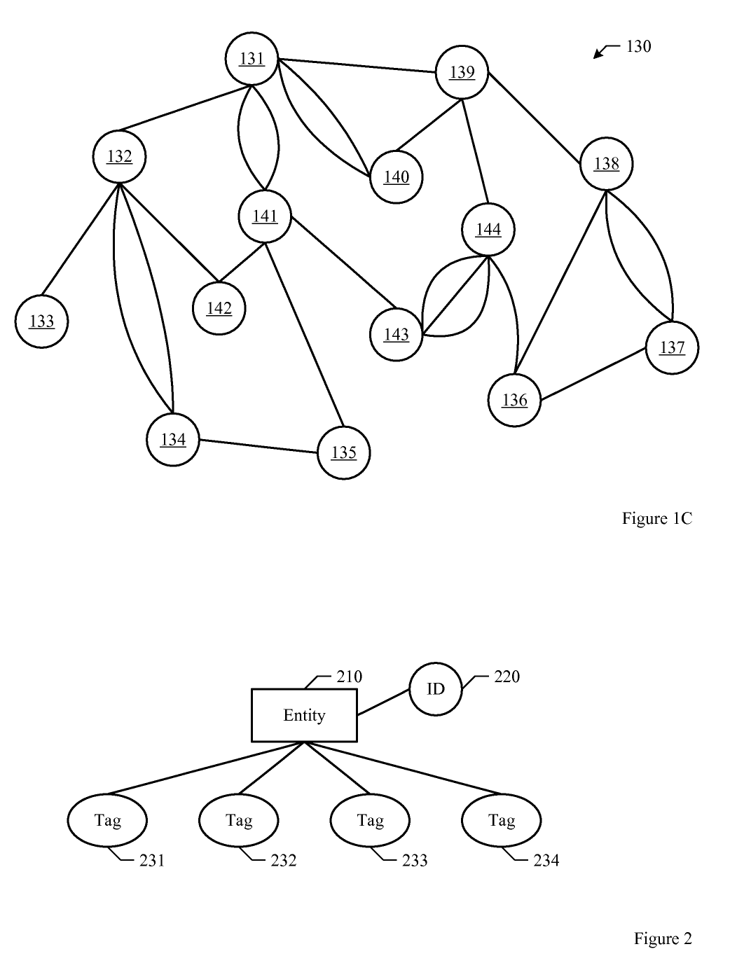

According to various embodiments, each real world entity may be assigned a unique identifier (ID). Similarly, each virtual world entity may also be assigned a unique ID. The ID may be alphanumeric. In addition, one or more tags may be associated with an entity. In the context of the present disclosure, a “tag” refers to a free-form string that usually describes one or more aspects or attributes of the entity with which it is associated. Generally, the tags are visible to the general public, i.e., people other than the person creating the tags. Thus, an entity may be identified with a unique ID and may be associated with one or more tags. FIG. 2 illustrates an entity 210 that has a unique ID 220 and is associated with four tags 231, 232, 233, 234.

A tag may also be associated with a group of related entities. As explained above, multiple entities may be connected, such as by an event. For example, an event may include one or more people entities, a time entity, a location entity, and one or more activity entities. A tag may be associated with the event as a whole, which encompasses several individual entities of various types.

A tag may be associated with an entity one or more times, i.e., the frequency a tag is associated with an entity. This often results from multiple people associating the same tag with the same entity. For example, thousands of tourists visit the Golden Gate Bridge in San Francisco each year. Many of these tourists may associate the tag “vacation” with the Golden Gate Bridge In another example, many people attend opera performances at the War Memorial Opera House in San Francisco, the thus many may associate the tag “opera” with the War Memorial Opera House.

A tag that is associated with an entity often describes the entity in some aspect or attribute. For example, a photograph may have several tags indicating the location the photograph was taken, the time the photograph was taken, the person who took the photograph, the device used to take the photograph, the content of the photograph, etc. A media file may have several tags indicating the title of the file, the name of the artist, the name of the album, the genera of the media, etc.

A tag may be explicit or implicit. An explicit tag is specifically created for an entity and associated with the entity, usually by a person. For example, when a person uploads his or her photographs online, he or she may provide tags for each photograph, describing the content and other information of each photograph. Similarly, when a person uploads a media (e.g., music or video) file online, he or she may provide tags for the content of the media file, the name of the composer and/or performer, the date of the production, the genre, the format of the file, etc.

An implicit tag may be inferred from different sources, such as the context of the entity, the activities surrounding the entity, etc. For example, if a person makes a telephone call on his or her mobile telephone, based on the location of the mobile telephone and the time of the telephone call, implied tags may be generated that indicate that the person is at the location of the mobile telephone during the time of the telephone call. In another example, if a person purchases a round-trip plane ticket to Hawaii for the first week of July, it may be inferred that the person is in Hawaii during the first week of July, even if the person does not provide any explicit information about his or her trip. In a third example, suppose it is know that a particular person is very interested in fishing and often goes to Halfmoon Bay, Calif. to fish. The tag “fishing” may be inferred for Halfmoon Bay based on this information to indicate that Halfmoon Bay is a popular location for fishing. In some cases, tags may be derived from the metadata available in the files.

Sometimes, people create self-referential tags with respect to an entity or a group of related entities. For example, when a person travels from one location to anther location, he or she may take photographs of various points along the route at various times. He or she may provide a tag for each photograph, indicating that the particular photograph was taken at a particular location at a particular time along the route he or she has traveled. Consequently, the tag also indicates that the person was at such location at such time. As a result, the person is associated with the specific location-time. In addition to tagging other entities, a person may also tag himself or herself. If a person is interested in photography, he or she may tag himself or herself as a “photographer.” In this way, self-referencing tags may be used to describe one's attributes or aspects.

Often, multiple people may associate the same tag with the same entity, and consequently, an entity may be associated with the same tag multiple times. For example, many people visit the Golden Gate Bridge in San Francisco each year, and they take photographs to memorize the occasions. Some of these people come to San Francisco on vacation, and as a result, they may associate the tag “vacation” with their photographs of the Golden Gate Bridge as well as other San Francisco landmarks. As a result, the Golden Gate Bridge may be associated with the “vacation” tag many times. Similarly, many people visit the Napa valley for wine tasting each year. As a result, many people may associate the tag “wine” with the Napa valley. Basketball is a popular game that many people enjoy, and many people may associate the tag “sport” with Basketball.

In one sense, tags represent people's interest in the entities with which they are associated. If a person explicitly associates the tag “wine” with Napa, it may suggest that the person is interested in wine and/or Napa. If a person attends a basketball game, it may suggest that the person is interested in basketball, and an implied tag may be associated with the person.

Since tags are free-form strings, multiple strings may describe the same or similar concept, and thus are equivalent for the present purpose. For example, “bicycling” and “biking” both refer to the same activity; “Italian food” and “Italian cuisine” both refer to the same type of food. According to some embodiments, these equivalent tag strings may be considered the same for targeted advertisement purposes. In other words, the tags may be normalized so that two equivalent tags are considered the same tag.

In practice, there may be thousands of tags associated with the various entities. For each tag, some entities are more representative of the tag than other entities. An entity is relatively more representative of a tag if the tag is relatively more uniquely and/or frequently associated with that entity. In other words, the more uniquely and/or frequently a tag is associated with an entity, the more representative the entity is for the tag. Theoretically for uniqueness, at one extreme, if a tag is only associated with a single entity, then that entity is the most representative entity of that tag since the tag is absolutely unique to the entity. At the other extreme, if a tag is associated with most of the entities, then none of the entities is representative of the tag since the tag is not unique to any of the entities. In addition, if a tag is associated with an entity many times, then that entity is more representative of the tag. Conversely, if a tag is not associated with an entity or is associated with an entity only a few times, then that entity is less representative or not representative of the tag.

According to various embodiments, for each available tag, the most representative entities, such as locations, time, activities, and/or users, are determined using term frequency-inverse document frequency (tf-idf). The tf-idf weight is often used in information retrieval and text mining. The weight is a statistical measure used to evaluate how important a word is to a document in a collection or corpus. As applied to the context of the present disclosure, the tf-idf weight is a statistical measure used to evaluate how important a tag is to a particular entity among a set of entities that includes the entity. The term frequency (tf) is the number of times a given tag is associated with each entity within the set. Optionally, the count may be normalized to prevent various forms of bias. The inverse document frequency is a measure of the general importance of the tag.

According to various embodiments, the location entities may be organized hierarchically, as illustrated in FIG. 1A, where a larger location encompasses multiple smaller locations. For example, the world encompasses multiple continents, each continent encompasses multiple countries, each country encompasses multiple states or provinces, each state or province encompasses multiple cities, each city encompasses multiple streets, and so on. Of course, it is not necessary to divide the geographical locations according to continents, countries, states, cities, etc. Any granularity level may be used, such that a larger region encompasses multiple smaller regions, and so on.

Using continents, countries, states, cities as an example for convenience, each city may be associated with one or more tags, each state may be associated with one or more tags, each country may be associated with one or more tags, each continent may be associated with one or more tags, and so on. To determine whether a tag is unique to a particular location, e.g., a city, the other cities within the same state, the same country, or the same continent are examined to determine the number of other cities with which the same tag is associated. If the tag is only associated with a few other cities, then the tag is unique to the few cities with which it is associated. If the tag is associated with many cities, then the tag is not unique to any of the cities with which it is associated.

In other words, each entity is compared against a larger set of entities that includes the entity to determine the number of entities within the set with which a particular tag is associated. If the tag is only associated with a relatively smaller number of entities within the set, then the tag is unique to these few entities. If the tag is associated with a relatively larger number of entities within the set, then the tag is not unique to any of the entities. The set of entities may be of any size. For a city, it may be compared against all the other cities within the same state, all the other cities within the same country, all the other cities within the same continent, and even all the other cities in the world separately. At each granularity level, the uniqueness of a tag with respect to a city may be determined. Consequently, the level of representativeness the city provides the tag may be determined at different granularity levels.

As described above, the entities may be divided into categories and subcategories. One skilled in the art will appreciate that the entity categories or subcategories may be based on any concept or model. Although in the context of the W4 data, a natural category division may be based on the “where,” “when,” “who,” and “what,” other categories are equally possible. The categories may be divided based on any single concept or a combination of concepts.

The most representative entities to a tag may be determined within each category or subcategory. In this case, only the entities within the particular category or subcategory are analyzed using the tf-idf weights, instead of all the entities.

In addition, the most representative entities to a tag may be determined for a specific group of people, e.g., for people of a particular gender, for people from a particular age group, for people having a particular profession, for people within an income bracket, etc. To determine the most representative entities to a tag for a specific group of people, only the explicit or implicit tags that are associated with the entities by the people from the specific group are used in the tf-idf analysis. One skilled in the art will appreciate that because different people associate different tags to the entities, the most representative entities to a tag determined for one group of people often differ from the most representative entities to the same tag determined for another group of people.

### Targeted Advertisement

Using the tf-idf weights, the most representative entities, such as locations, time, activities, users, etc., for each tag may be determined. Furthermore, these entities may be ranked for a tag based on their levels of representativeness, i.e., the tf-idf weights, with respect to the tag. According to various embodiments, the entities may be divided into categories and subcategories, and the most representative entities within each category may be determined for each tag. For example, for a particular tag, the most representative locations, time, activities, people, etc., may be separately determined. Such information may then be used for targeted advertisement.

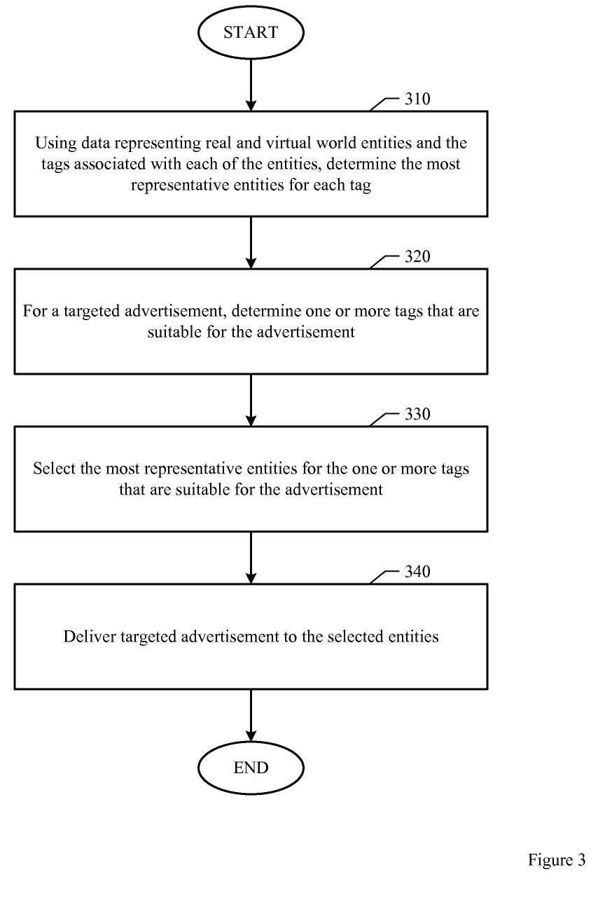

FIG. 3 illustrates a method of targeted advertisement according to one embodiment of the present disclosure. As explained before, W4 data representing entities may be generated and collected in a variety of ways, one of which is within the context of the W4 COMN. Similarly, tags associated with the entities may be obtained in a variety of ways as well, including explicit tags, implicit tags, self-referencing tags, etc. Using the collected W4 data and tag information, for each tag, the most representative entities are determined using their tf-idf weights (step 310). Since the W4 data represent different types of entities, such as locations, people, time, activities, objects, topics, etc., the most representative entities for each tag may also be divided into categories. Thus, for each tag, the most representative locations, the most representative time, the most representative activities, etc. may be separately determined.

For example, for the tag “wine”, the most representative locations may be Napa, Bordeaux, Burgundy, and Tuscany; the most representative activities may be wine collection, wine festival, wine tasting, winery visits, and wine making classes; the most representative time intervals may be August, September, and October; and the most representative people may include wine connoisseurs, wine club members, or people who visit wineries on a regular basis.

According to various embodiments, the most representative entities for each tag may be determined and stored in memory ahead of time so that the information is readily available when needed. In addition, from time to time or as new data becomes available, the most representative entities for each tag may be redetermined based on the new information.

Subsequently, the information may be used for targeted advertisement. When an advertiser wants to conduct targeted advertisement, one or more tags that are suitable for the advertisement are determined (step 320). The suitable tags usually are related to the content or subject matter of the advertisement. The tags may be explicitly specified or implicitly inferred from the content of the advertisement. For example, if a wine maker wishes to advertise its products, it may choose the tag “wine” as a suitable tag for its advertisement. Moreover, depending on the actual products, the wine maker may choose more specific tags, such as “red wine,” “white wine,” “champagne,” etc., for its advertisement.

Alternatively or in addition, the tags may be inferred from the subject matter or content of the advertisement. For example, if the advertisement relates to red wine, the tags may be “wine” or “red wine.” Similarly, since the advertiser is a wine maker, it may be inferred that the advertisement is related to “wine.” Some advertisement includes keywords, which may be used to determine the suitable tags. Of course, more than one tag may be selected or inferred for an advertisement.

The most representative entities, e.g., locations, time, people, activities, etc., for the tags that are suitable for the advertisement are selected (step 330). As described above, according to various embodiments, the most representative entities for each tag may be determined based on the collected W4 data and tag information using the tf-idf weights. Since the entities may be divided into categories and subcategories and within each category or subcategory, the entities may be ranked according to their levels of representativeness for a tag, the entities may be selected based on their rankings within their individual categories. For example, if the wine maker wishes to know the top three locations that are most representative for the tag “wine,” Napa, Bordeaux, and Burgundy selected.

In addition, what entities are most representative to a tag may vary based on the targeted people. As described above the level of the representativeness may vary depending on the data used. For example, the most representative entities to a tag determined based on tag data provided by females may differ from the representative entities to the same tag determined based on tag data provided by. Similarly, the most representative entities to a tag determined based on tag data provided people from one age group may differ from the representative entities to the same tag determined based on tag data provided from another age group. Thus, the most representative entities may be determined for a specific audience.

Thereafter, the advertisement is delivered to the selected most representative entities in a variety of suitable ways (step 340). By selecting the most representative entities for the tags that are related to an advertisement and targeting the advertisement to such entities, the efficiency and effectiveness of the advertisement may be improved.

To further explain the method illustrated in FIG. 3, consider the following example. Suppose there is a tag “opera” and this tag has been associated with various entities, either explicitly or implicitly. It may be assumed that the necessary W4 data and tag information have been collected using suitable methods. Suppose the “opera” tag is uniquely and frequently associated with the following geographical locations: New York, San Francisco, Paris, Sydney, and Rome. Similarly, the “opera” tag is uniquely and frequently associated with the following time intervals: weekend evenings and winter months, as well as with those people who attend opera performances on a regular basis (e.g., seasonal opera ticket holders). Thus, the most representative geographical locations for the “opera” tag are New York, San Francisco, Paris, Sydney, and Rome, the most representative time intervals for the “opera” tag are weekend evenings and winter months; and the most representative people for the “opera” tag are the seasonal opera ticket holders.

Subsequently, if an opera company wishes to conduct targeted advertisement about its performances in the upcoming season, the company may want to know the most effective geographical locations for delivering its advertisement. Since the advertisement is about opera performances, the “opera” tag is suitably related to the content of the advertisement. Based on the above information, the opera company may target its advertisement in New York, San Francisco, Paris, Sydney, and Rome since these cities, i.e., geographical locations, are the most representative geographical locations for the “opera” tag.

The target is not necessarily limited to locations only. An advertisement may be targeted to selected time intervals, selected consumer or user groups, etc. instead or in addition to the selected locations. In this example, the most representative time intervals for the “opera” tag are weekend evening and winter months; thus, the opera company may target its advertisement in New York, San Francisco, Paris, Sydney, and Rome only during winter months. The most representative people for the “opera” tag are the seasonal opera ticket holders; thus, the opera company may target its advertisement in New York, San Francisco, Paris, Sydney, and Rome only during winter months and only to the seasonal opera ticket holders.

One skilled in the art will understanding that by determining the most representative entities for each tag and by matching selected tags to an advertisement, the advertisement may be targeted to the most representative locations (the “where”), time intervals (the “when”), consumer groups (the “who”), and/or any other desirable categories (the “what”). Furthermore, multiple tags may be related to an advertisement, and the most representative entities for the targeted advertisement may be further narrowed based on an intersection of the most representative entities for each of the individual tags. For example, suppose there is a second tag “Italian music,” for which the most representative locations are New York, Rome, Florence, and Venice. If the opera company's upcoming performances include mostly operas by famous Italian composers, the company may choose both the “opera” tag and the “Italian music” tag to represent the content of its advertisement. In this case, there are two cities, New York and Rome, that are commonly representative to the two tags, “opera” and “Italian music.” The company may select only these two cites as the locations for its targeted advertisement.

The concept may apply to virtual world entities as well. For example, there are virtual locations such as online chat rooms, blogs, virtual game environments, websites, etc., and it is possible to associate tags with these virtual locations. The “opera” tag may be associated with websites focusing on classical music or opera in particular or with chat rooms or blogs discussing opera performances, opera composers, etc. The most representative virtual entities for each tag may be similarly determined using tf-idf weights. Thereafter, when an advertiser wishes to conduct targeted advertisement online, the virtual locations and/or online user IDs may be selected based on the tags suitable for the advertisement. For example, the opera company may choose to place banner ads at websites or blogs discussing opera performances.

The advertisement may be delivered to the selected entities in a variety of suitable ways. In the above example, the advertisement may be delivered to a seasonal opera ticket holder when he or she visits one of the selected cities during one of the winter months. The advertisement may take the form of an email or instant message and sent to the person's mobile device at the appropriate time. If a targeted location is chosen, then the advertisement may be delivered to a person only when that person is inside or in close proximity to the location. Since the mobile device helps locate the person's whereabouts, the mobile device may be used to determine whether the person is in one of the selected cities at a given moment. Consequently, suitable locations, time, people, activities, etc. may be selected for targeted advertisement.

Sometimes, it may be necessary to go through third parties to deliver an advertisement. For example, if an advertisement is to be delivered to a person's mobile telephone, it may be necessary to go through the person's wireless service provider in order to deliver the advertisement.

The most representative entities, i.e., locations, time intervals, activities, etc., not only provide advertisers with desirable targets of their advertisements, they may also help advertisers and/or advertising service providers generate new advertising and business opportunities. Sometimes, knowing the most representative entities for the tags may help the advertisers tailor the advertisement to these entities. For example, an advertisement targeted for a location in Asia may have a different cultural flavor than an advertisement targeted for a location in Europe, which may have a different cultural flavor than an advertisement targeted for a location in Africa. By knowing that several regions in France are most representative of the tag “wine,” a wine maker may have an advertisement specifically designed for the French regions. Similarly, advertisements targeted for different demographical groups may have different flavors.

Other times, some advertisers may have an inventory of advertisements but are not certain which advertisement is suitable for which target. In this case, each advertisement may be matched with one or more tags based on the subject matter or content of the advertisement, and the most representative entities of the matched tags may be used as the targets for the advertisement.

### Computer System

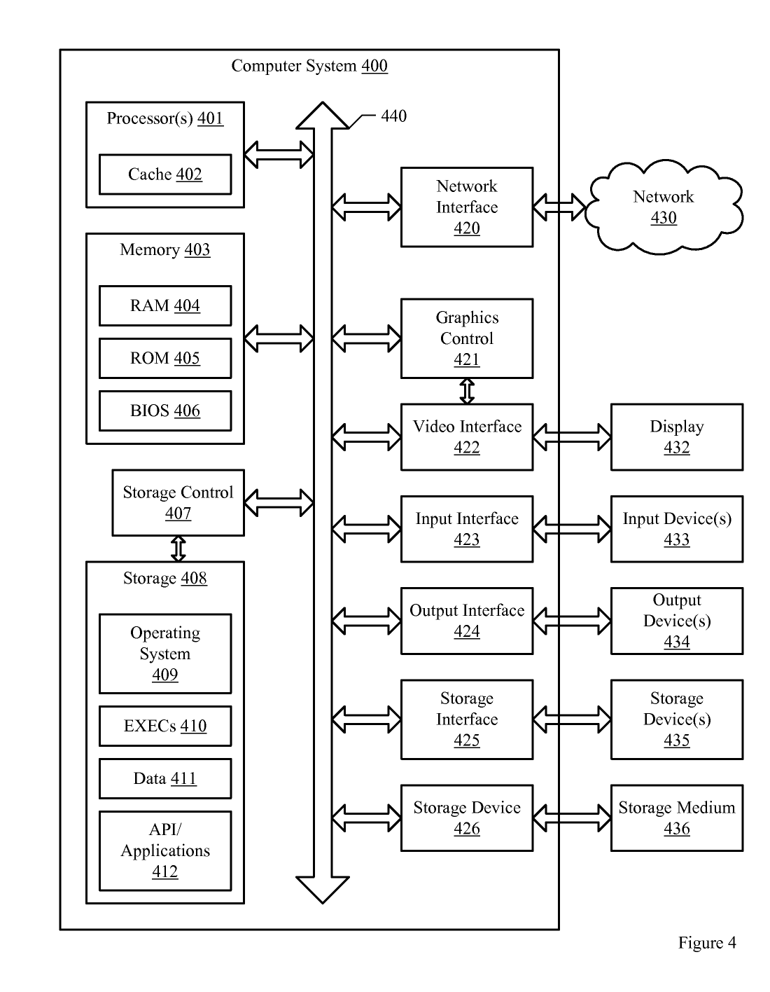

The targeted advertisement method described above may be implemented as computer software using computer-readable instructions and stored in computer-readable medium. The software instructions may be executed on various types of computers. For example, FIG. 4 illustrates a computer system 400 suitable for implementing embodiments of the present disclosure. The components shown in FIG. 4 for computer system 400 are exemplary in nature and are not intended to suggest any limitation as to the scope of use or functionality of the API. Neither should the configuration of components be interpreted as having any dependency or requirement relating to any one or combination of components illustrated in the exemplary embodiment of a computer system. The computer system 400 may have many physical forms including an integrated circuit, a printed circuit board, a small handheld device (such as a mobile telephone or PDA), a personal computer or a super computer.

Computer system 400 includes a display 432, one or more input devices 433 (e.g., keypad, keyboard, mouse, stylus, etc.), one or more output devices 434 (e.g., speaker), one or more storage devices 435, various types of storage medium 436.

The system bus 440 link a wide variety of subsystems. As understood by those skilled in the art, a “bus” refers to a plurality of digital signal lines serving a common function. The system bus 440 may be any of several types of bus structures including a memory bus, a peripheral bus, and a local bus using any of a variety of bus architectures. By way of example and not limitation, such architectures include the Industry Standard Architecture (ISA) bus, Enhanced ISA (EISA) bus, the Micro Channel Architecture (MCA) bus, the Video Electronics Standards Association local (VLB) bus, the Peripheral Component Interconnect (PCI) bus, the PCI-Express bus (PCI-X), and the Accelerated Graphics Port (AGP) bus.

Processor(s) 401 (also referred to as central processing units, or CPUs) optionally contain a cache memory unit 402 for temporary local storage of instructions, data, or computer addresses. Processor(s) 401 are coupled to storage devices including memory 403. Memory 403 includes random access memory (RAM) 404 and read-only memory (ROM) 405. As is well known in the art, ROM 405 acts to transfer data and instructions uni-directionally to the processor(s) 401, and RAM 404 is used typically to transfer data and instructions in a bi-directional manner. Both of these types of memories may include any suitable of the computer-readable media described below.

A fixed storage 408 is also coupled bi-directionally to the processor(s) 401, optionally via a storage control unit 407. It provides additional data storage capacity and may also include any of the computer-readable media described below. Storage 408 may be used to store operating system 409, EXECs 410, application programs 412, data 411 and the like and is typically a secondary storage medium (such as a hard disk) that is slower than primary storage. It should be appreciated that the information retained within storage 408, may, in appropriate cases, be incorporated in standard fashion as virtual memory in memory 403.

Processor(s) 401 is also coupled to a variety of interfaces such as graphics control 421, video interface 422, input interface 423, output interface, storage interface, and these interfaces in turn are coupled to the appropriate devices. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, or other computers. Processor(s) 401 may be coupled to another computer or telecommunications network 430 using network interface 420. With such a network interface 420, it is contemplated that the CPU 401 might receive information from the network 430, or might output information to the network in the course of performing the above-described method steps. Furthermore, method embodiments of the present disclosure may execute solely upon CPU 401 or may execute over a network 430 such as the Internet in conjunction with a remote CPU 401 that shares a portion of the processing.

In addition, embodiments of the present disclosure further relate to computer storage products with a computer-readable medium that have computer code thereon for performing various computer-implemented operations. The media and computer code may be those specially designed and constructed for the purposes of the present disclosure, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter.

As an example and not by way of limitation, the computer system having architecture 400 may provide functionality as a result of processor(s) 401 executing software embodied in one or more tangible, computer-readable media, such as memory 403. The software implementing various embodiments of the present disclosure may be stored in memory 403 and executed by processor(s) 401. A computer-readable medium may include one or more memory devices, according to particular needs. Memory 403 may read the software from one or more other computer-readable media, such as mass storage device(s) 435 or from one or more other sources via communication interface. The software may cause processor(s) 401 to execute particular processes or particular steps of particular processes described herein, including defining data structures stored in memory 403 and modifying such data structures according to the processes defined by the software. In addition or as an alternative, the computer system may provide functionality as a result of logic hardwired or otherwise embodied in a circuit, which may operate in place of or together with software to execute particular processes or particular steps of particular processes described herein. Reference to software may encompass logic, and vice versa, where appropriate. Reference to a computer-readable media may encompass a circuit (such as an integrated circuit (IC)) storing software for execution, a circuit embodying logic for execution, or both, where appropriate. The present disclosure encompasses any suitable combination of hardware and software.

While this disclosure has described several preferred embodiments, there are alterations, permutations, and various substitute equivalents, which fall within the scope of this disclosure. It should also be noted that there are many alternative ways of implementing the methods and apparatuses of the present disclosure. It is therefore intended that the following appended claims be interpreted as including all such alterations, permutations, and various substitute equivalents as fall within the true spirit and scope of the present disclosure.

What is claimed is:

1. A method, comprising:
accessing at least one tag relating to an advertisement, wherein the at least one tag is among a plurality of tags;
selecting at least one entity that is most representative of the at least one tag; and
targeting the advertisement to the at least one entity.

2. A method as recited in claim 1, further comprising:
for each of the plurality of tags, determining at least one most representative entity, wherein an entity is relatively more representative of a tag if the tag is at least relatively more uniquely associated with the entity.

3. A method as recited in claim 2, wherein an entity is relatively more representative of a tag if the tag is further relatively more frequently associated with the entity.

4. A method as recited in claim 2, wherein the at least one most representative entity for a tag is determined based on a term frequency-inverse document frequency weight of each of the at least one most representative entity.

5. A method as recited in claim 1, further comprising:
for each of the plurality of tags, determining at least one most representative entity for a group of users,
wherein an entity is relatively more representative of a tag if the tag is relatively more uniquely and relatively more frequently associated with the entity, and
wherein only entities with which the group of users has associated tags are analyzed to determine the at least one most representative entity.

6. A method as recited in claim 1, further comprising:
parsing the advertisement to determine the at least one tag related to the advertisement.

7. A method as recited in claim 1, further comprising:
receiving the at least one tag related to the advertisement.

8. A method as recited in claim 1, further comprising:
delivering the advertisement to the at least one entity.

9. A method as recited in claim 1, wherein each of the at least one entity exists in a real world or a virtual world.

10. A method as recited in claim 9, wherein each of the at least one entity is one selected from the group consisting of: a geographical location, a virtual location, a person, a user ID, a time interval, a point in time, an event, an activity, a topic, and a concept.

11. A method as recited in claim 9, wherein each of the at least one entity is one selected from the group consisting of: a geographical location, a virtual location, a time interval, a point in time, and an activity.

12. A method as recited in claim 1, wherein if the at least one tag related to the advertisement comprises two or more tags, then the at least one entity that is most representative of the at least one tag is at least one common entity that is most representative to each of the at least one tag.

13. A method, comprising:
accessing at least one tag relating to an advertisement, wherein the at least one tag is among a plurality of tags;
selecting at least one geographical location that is most representative of the at least one tag, wherein a geographical location is relatively more representative of a tag if the tag is relatively more uniquely and frequently associated with the geographical location; and
targeting the advertisement at least to the at least one geographical location.

14. A method as recited in claim 13, further comprising:
selecting at least one time that is most representative of the at least one tag, wherein a time is relatively more representative of a tag if the tag is relatively more uniquely and frequently associated with the time; and
targeting the advertisement further to the at least one time.

15. A method as recited in claim 14, further comprising:
selecting at least one person that is most representative of the at least one tag, wherein a person is relatively more representative of a tag if the tag is relatively more uniquely and frequently associated with the person; and
targeting the advertisement further to the at least person.

16. A method as recited in claim 15, wherein targeting the advertisement to the at least one geographical location, the at least one time, and the at least one person comprises delivering the advertisement to each of the at least one person only during one of the at least one time and while the person is within one of the at least one geographical location.

17. A method as recited in claim 15, further comprising:
for each of the plurality of tags, determining at least one most representative geographical location, at least one most representative time, and at least one most representative person using term frequency-inverse document frequency.

18. A method as recited in claim 14, further comprising:
receiving an advertising offer with respect to the advertisement and desirable target categories;
parsing the advertisement to automatically determine the at least one tag related to the advertisement; and
providing at least one most representative location, time, and person based on the desirable target categories.

19. A method as recited in claim 14, further comprising:
receiving an advertising offer with respect to the advertisement and desirable target categories;
receiving the at least one tag related to the advertisement; and
providing at least one most representative location, time, and person based on the desirable target categories.

20. A computer program product comprising a computer-readable medium having a plurality of computer program instructions stored therein, wherein the plurality of computer program instructions are operable to cause at least one computing device to:
access at least one tag relating to an advertisement, wherein the at least one tag is among a plurality of tags;
select at least one entity that is most representative of the at least one tag; and
target the advertisement to the at least one entity.

21. A computer program product as recited in claim 20, wherein the plurality of computer program instructions are further operable to:
for each of the plurality of tags, determine at least one most representative entity, wherein an entity is relatively more representative of a tag if the tag is relatively more uniquely and more frequently associated with the entity.

22. A computer program product as recited in claim 20, wherein the at least one entity comprises at least one geographical location, at least one time, and at least one person, and wherein target the advertisement to the at least one entity comprises deliver the advertisement to each of the at least one person only during one of the at least one time and while the person is within one of the at least one geographical location.
